(19) United States
(12) Patent Application Publication
(10) Pub. No.: US 2010/0191954 A1
(43) Pub. Date: Jul. 29, 2010

(54) METHOD AND APPARATUS FOR TRANSMITTING MESSAGE IN HETEROGENEOUS FEDERATED ENVIRONMENT, AND METHOD AND APPARATUS FOR PROVIDING SERVICE USING THE MESSAGE

(75) Inventors: Seung Hyun Kim, Daegu (KR); Dae Seon Choi, Daejeon (KR); Jong Hyouk Noh, Daejeon (KR); Sang Rae Cho, Daejeon (KR); Yeong Sub Cho, Daejeon (KR); Seung Hun Jin, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/095,560

(22) PCT Filed: Dec. 1, 2006
(86) PCT No.: PCT/KR06/05151

§ 371 Date: May 30, 2008

(30) Foreign Application Priority Data
Dec. 1, 2005 (KR) 10-2005-0116593

(51) Int. Cl. G06F 15/16; G06F 21/00; H04L 9/00

(52) U.S. Cl. 713/150; 709/206; 726/3

(57) ABSTRACT

Provided are a method and apparatus for transmitting a message in a heterogeneous federated environment, and a method and apparatus for providing a service according to the message. In the method of transmitting a message to an external domain in the heterogeneous federated environment, a service server of a domain creates a transmission message to be transmitted to the external domain and supplies it to a protocol interpretation unit of the domain. The protocol interpretation unit detects protocol information of the external domain, interprets the created transmission message based on the detected protocol information, and supplies the interpreted transmission message to the service server. The service server then supplies the interpreted transmission message to the external domain. Accordingly, two service servers in different domains with different protocol information can exchange messages with each other while guaranteeing security.

### TECHNICAL FIELD

The present invention relates to a method and apparatus for transmitting a message in a heterogeneous federated environment and a method and apparatus for providing a service using the message, and more particularly, to a service providing a method and apparatus in a heterogeneous federated environment, in which two service servers in different domains transform protocol information of a message to be transmitted or a message received via at least a protocol interpreter, and provide a service according to the transformed information.

### BACKGROUND ART

Various techniques have been introduced to reduce the authentication burdens between a user and a computer device manager. These techniques are generally referred to as ‘single sign-on (SSO)’ processes because they have a common purpose: after a user has completed a sign-on operation, i.e., the user has been authenticated, the user is not subsequently needed to perform another authentication operation. SSO processes are designed so that user need only for the user to complete an authentication process once during a specific user session.

SSO solutions have been successful when implemented within a given enterprise. However, the more enterprises participating in electronic commerce marketplaces or other collaborative endeavors, the more barriers that are set by a plurality of authentication processes or systems.

Previous SSO solutions between enterprises have been limited to homogeneous environments in which there are pre-established business agreements between participating enterprises. Each individual enterprise knows how to create and interpret authentication assertions that can be understood by other enterprises that have exchanged similar agreements, such as enterprises within an electronic commerce marketplace. The homogeneous environments are tightly coupled since there is a deterministic relationship disclosed by enterprises mapping the identity of users over the system.

Enterprises participating in the SSO solutions may cooperate within homogeneous environments by using previous SSO solutions. However, in an external federated domain using a different security policy or a different federated protocol, the enterprises must establish a trust relationship, and create and interpret an understandable federated protocol message so as to cooperate with servers in the domain. If a plurality of devices have the trust relationship, there is a need for a method and apparatus for providing a solution to a complicated mapping between different federated protocols.

A method of operating federated domains together in a federated environment is disclosed in Korean Patent Application No. 10-2005-7008492, entitled ‘Method and System for Native Authentication Protocols in a Heterogeneous Federated Environment’, and International Patent Application No. PCT/EP2003/014852, entitled ‘Method and System for Authentication in a Heterogeneous Federated Environment, i.e., Single Sign On in Federated Domains’. In this case, a server within a domain relies upon a trust proxy within the domain to manage trust relationships between the domain and a federation. The trust proxy generates and interprets authentication assertions. The trust proxy may have a trust relationship with a trust arbiter and rely upon the trust arbiter for assistance in interpreting the authentication assertions.

However, this method is focused on exchange of authentication assertions, and in particular, establishing of a dynamic trust relationship via the trust arbiter. Also, this method demonstrates that the trust proxy manages authentication information and generates authentication assertions, but does not disclose compatibility between federated protocols.

### DISCLOSURE OF INVENTION

### Technical Problem

The present invention provides a method and apparatus for transmitting a message in a heterogeneous federated environment, in which two service servers in different domains transform protocol information via at least a protocol interpretation module for message compatibility, and a method and apparatus for providing a service according to the transform protocol information result.

### Technical Solution

According to an aspect of the present invention, there is provided a method of transmitting a message from a domain to an external domain in a heterogeneous federated environment, the method comprising (a) a service server of the domain creating a transmission message to be transmitted to the external domain, and supplying the transmission message to a protocol interpretation unit of the domain; (b) the protocol interpretation unit of the domain detecting protocol information of the external domain; (c) the protocol interpretation unit of the domain interpreting the transmission message created in (a) based on the detected protocol information of the external domain, and supplying the interpreted transmission message to the service server; and (d) the service server of the domain transmitting the transmission message interpreted in (c) to the external domain.

According to another aspect of the present invention, there is provided a method of providing a service, in which a domain receives a transmission message from an external domain and provides a service corresponding to the transmission message in a heterogeneous federated environment, the method comprising (a) a service server of the domain determining whether protocol information contained in the transmission message is the same as protocol information of the domain; (b) when it is determined in (a) that the protocol information contained in the transmission message is not the same as protocol information of the domain , the service server of the domain supplying the transmission message to a protocol interpretation unit of the domain; (c) the protocol interpretation unit interpreting the transmission message by using the protocol information of the domain, and supplying the interpreted result to the service server of the domain; and (d) the service server of the domain analyzing the interpreted transmission message and providing a service according to the analysis result.

According to an aspect of the present invention, there is provided an apparatus for transmitting a message in a heterogeneous federated environment, the apparatus comprising a storage unit storing protocol information of an external domain in the heterogeneous federated environment; a protocol interpretation unit loading the protocol information of the external domain from the storage unit, and interpreting a transmission message, which is to be transmitted to the external domain, based on the protocol information of the external domain; and a service server creating the transmission message, supplying the transmission message to the protocol interpretation unit, receiving the interpreted transmission message from the protocol interpretation unit, and transmitting the interpreted transmission message to the external domain.

According to an aspect of the present invention, there is provided an apparatus for providing a service, in which a domain receives a transmission message from an external domain and provides a service corresponding to the transmission message in a heterogeneous federated environment, the apparatus comprising a storage unit storing protocol information of the domain comprising the storage unit; a protocol interpretation unit receiving a transmission message, and interpreting the transmission message by using the protocol information loaded from the storage unit; and a service server analyzing protocol information contained in the transmission message to determine whether the contained protocol information is the same as the protocol information of the domain, and when it is determined that the contained protocol information and the protocol information of the domain are not the same, supplying the transmission message to the protocol interpretation unit, receiving and analyzing the interpreted transmission message from the protocol interpretation unit, and providing a service according to the analysis result.

### ADVANTAGEOUS EFFECTS

two service servers in different domains with different protocol information can exchange messages with each other while guaranteeing security.

### DESCRIPTION OF DRAWINGS

FIG. 1 is a block diagram of a system including an apparatus that transmits a message in a heterogeneous federated environment and an apparatus that provides a service using the message, according to an embodiment of the present invention;

FIG. 2 is a flowchart illustrating a method of transmitting a message in a heterogeneous federated environment, according to an embodiment of the present invention; and

FIG. 3 is a flowchart illustrating a method of providing a service using a message received in a heterogeneous federated environment, according to an embodiment of the present invention.

### BEST MODE

A method of transmitting a message from a domain to an external domain in a heterogeneous federated environment, the method comprising:
(a) a service server of the domain creating a transmission message to be transmitted to the external domain, and supplying the transmission message to a protocol interpretation unit of the domain;
(b) the protocol interpretation unit of the domain detecting protocol information of the external domain;
(c) the protocol interpretation unit of the domain interpreting the transmission message created in (a) based on the detected protocol information of the external domain, and supplying the interpreted transmission message to the service server; and
(d) the service server of the domain transmitting the transmission message interpreted in (c) to the external domain.

### MODE FOR INVENTION

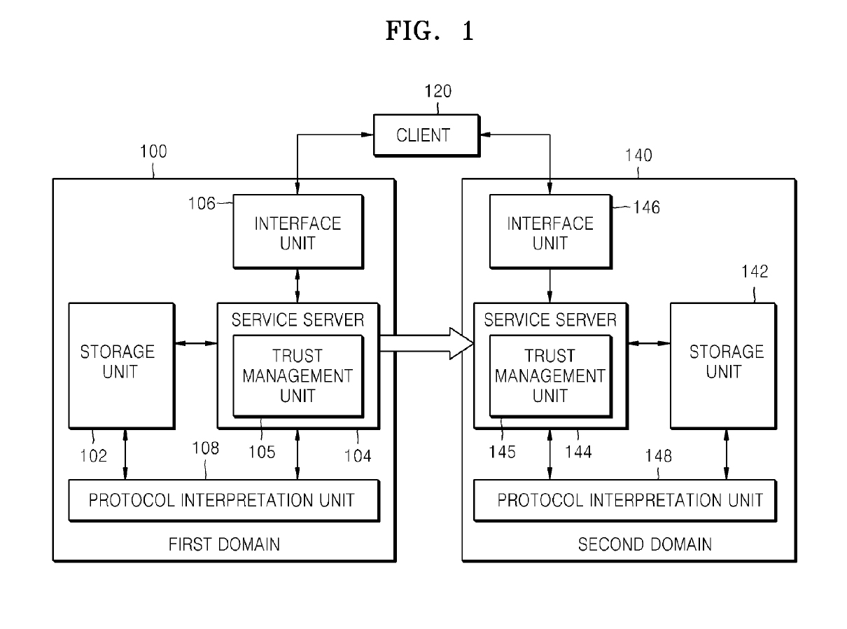

FIG. 1 is a block diagram of a system including an apparatus that transmits a message in a heterogeneous federated environment, and an apparatus that provides a service using the message, according to an embodiment of the present invention. Referring to FIG. 1, the system includes a first domain 100, a client 120, and a second domain 140.

It is assumed that the first and second domains 100 and 140 are located in a heterogeneous federated environment in which different security policies or federated protocols are used. In the heterogeneous federated environment, a trust relationship must be established between the first and second domains 100 and 140 to provide services from the first domain 100 to the second domain 140 or vice versa.

The establishment of a trust relationship between the first and second domains 100 and 140 means that messages can be directly exchanged therebetween with guaranteed security by using encryption/decryption and protocol transform techniques, not via an additional constituent element.

In this disclosure, the first domain 100 is a message transmitting apparatus that transmits a message to the second domain 140 in the heterogeneous federated environment, and the second domain 140 is a service providing apparatus that analyzes the message received from the first domain 100 and provides a service corresponding to the interpretation result in the heterogeneous federated environment.

The first domain 100 includes a storage unit 102, a service server 104, an interface unit 106, and a protocol interpretation unit 108. The service server 104 includes a trust management unit 105.

The storage unit 102 stores protocol information and security information of the first domain 100 and second domain 140.

The service server 104 is an object via which messages are exchanged between the first and second domains 100 and 140. The service server 104 establishes a trust relationship with a service server 144 of the second domain 140 and exchanges messages directly with the service server 144.

The interface unit 106 receives original message information, which is input by a user, and second domain information from the client 120. The original message information is used to create a transmission message to be transmitted from the first domain 100 to the second domain 140, and the second domain information is information regarding an external domain to which the created message is to be transmitted.

The service server 104 creates a transmission message to be transmitted, based on the original message information received via the interface unit 106, and supplies the created transmission message and the second domain information to the protocol interpretation unit 108.

The protocol interpretation unit 108 loads the protocol information of the second domain 140 from the storage unit 102 based on the received second domain information, and interprets the transmission message based on the protocol information of the second domain 140. Also, the protocol interpretation unit 108 returns the interpreted transmission message to the service server 104.

The service server 104 receives the interpreted transmission message and determines whether the transmission message is to be encrypted and transmitted. Specifically, the trust management unit 105 of the service server 104 determines whether the interpreted transmission message is to be encrypted and transmitted.

If the trust management unit 105 determines that the interpreted transmission message is to be encrypted and transmitted, the storage unit 102 loads the security information of the second domain 140, and encrypts the interpreted transmission message by using the loaded security information.

The service server 104 transmits the interpreted transmission message encrypted by the trust management unit 105 to the second domain 140 via a wire/wireless network.

If the trust management unit 105 determines that the interpreted transmission message will be transmitted without being encrypted, the service server 104 transmits the transmission message to the second domain 140 via the wire/wireless network.

The first domain 100 that transmits a transmission message to an external domain, such as the second domain 140 of FIG. 1, in the heterogeneous federated environment has been described.

The second domain 140 that receives transmission information from an external domain, such as the first domain 100 of FIG. 1, and provides a service corresponding to the transmission information in the heterogeneous federated environment will now be described.

The second domain 140 includes a storage unit 142, the service server 144, an interface unit 146, and a protocol interpretation unit 148. The service server 144 includes a trust management unit 145.

The storage unit 142 stores the protocol information and security information of the first domain 100 and the second domain 140.

The service server 144 is an object via which messages are exchanged between the second and first domains 140 and 100. The service server 144 establishes a trust relationship with the service server 104 of the first domain 100 and exchanges messages directly with the service server 104. A case where the service server 144 receives a transmission message directly from the service server 104 of the first domain 100 and provides a service corresponding to the transmission message via a wire/wireless network will now be described.

The trust management unit 145 of the service server 144 determines whether the transmission message from the service server 104 of the first domain 100 is encrypted. If it is determined that the transmission message is encrypted, the service server 144 decrypts the transmission message using the security information of the second domain 140, analyzes the decrypted transmission message, and provides a corresponding service. If it is determined that the transmission message is not encrypted, the service server 144 directly analyzes the transmission message and provides a corresponding service.

Next, a case where the protocol interpretation unit 148 of the second domain 140 receives a transmission message from the service server 104 or the protocol interpretation unit 108 of the first domain 100 and provides a corresponding service via a wire/wireless network will now be described.

The trust management unit 145 of the protocol interpretation unit 148 determines whether the transmission message from the service server 104 or the protocol interpretation unit 108 of the first domain 100 is encrypted. If it is determined that the transmission message is encrypted, the trust management unit 145 loads the security information of the second domain 140 from the storage unit 142 and decrypts the transmission message. Otherwise, the trust management unit 145 informs the service server 144 that the transmission message has not been encrypted.

Also, the service server 144 determines whether the protocol information contained in the transmission message received from the service server 104 of the first domain 100 is the same as the protocol information of the second domain 140. This is accomplished by extracting and comparing the protocol information from the transmission message received from the service server 104 of the first domain 100 with the protocol information of the second domain 140 loaded from the storage unit 142 in order to determine whether they are the same. If it is determined that the protocol information contained in the transmission message received from the service server 104 of the first domain 100 is the same as the protocol information of the second domain 140 are not the same, the service server 144 supplies the transmission message to the protocol interpretation unit 148. If it is determined that the protocol information contained in the transmission message received from the service server 104 of the first domain 100 is the same as the protocol information of the second domain 140 are the same, the service server 144 analyzes the transmission message and provides a corresponding service.

The protocol interpretation unit 148 interprets the transmission message from the service server 144 based on the protocol information of the second domain 140, and supplies the interpreted transmission message to the service server 144. Specifically, the protocol interpretation unit 148 loads the protocol information of the second domain 140 from the storage unit 142, and interprets the transmission message from the service server 144 based on the loaded protocol information.

The service server 144 analyzes the interpreted transmission message received from the protocol interpretation unit 148 and provides a service according to the interpreted transmission message.

The interface unit 146 of the second domain 140 receives the original message information, which is input by a user, and first domain information from the client 120.

The original message information is used to create a transmission message to be transmitted from the second domain 140 to the first domain 100, and the first domain information is information regarding an external domain to which the created transmission message is to be transmitted.

Similar to the first domain 100, the second domain 140 receives the original message information and the first domain information from the client 120 via the interface unit 146.

In this disclosure, the first domain 100 is described as a device that transmits the message to the second domain 140 in the heterogeneous federated environment, and the second domain 140 is described as a device that analyzes the message from the first domain 100 and provides a corresponding service in the heterogeneous federated environment.

However, the first domain 100 can not only transmit a message but also receive a transmission message from an external domain and provide a corresponding service. Also, the second domain 140 can not only provide a service but also receive the original message information and information regarding the external domain from the client 120 via the interface unit 146 and transmit the transmission message to the external domain.

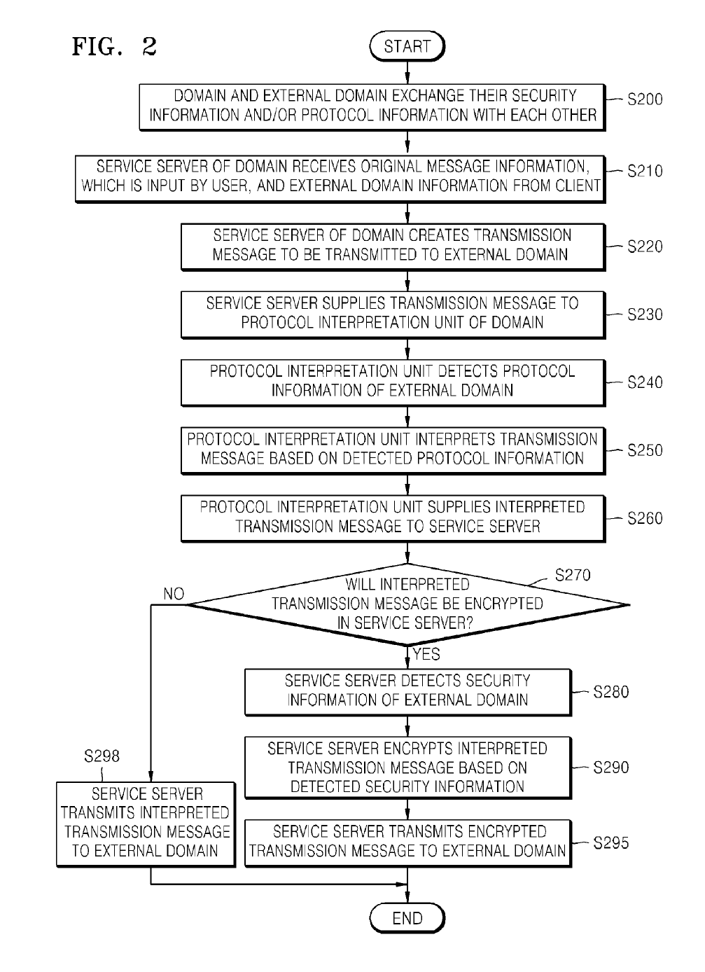

FIG. 2 is a flowchart illustrating a method of transmitting a message in a heterogeneous federated environment, according to an embodiment of the present invention. Referring to FIG. 2, first, a specific domain and an external domain exchange their security information and protocol information with each other (S200).

Next, a service server of the specific domain receives original message information, which is input by a user, and external domain information of the external domain to which a transmission message is to be transmitted, from a client via a user interface (S210). The original message information is used to create the transmission message to be transmitted from the service server of the specific domain to a service server of the eternal domain, and the external domain information is information regarding the external domain to which the transmission message is to be transmitted.

Next, the service server of the specific domain creates the transmission message to be transmitted to the external domain (S220).

Next, the service server of the specific domain outputs the created transmission message to a protocol interpretation unit of the specific domain (S230). Here, the service server of the specific domain inserts the external domain information into the created transmission message.

Next, the protocol interpretation unit of the specific domain detects protocol information of the external domain (S240).

Next, the protocol interpretation unit of the specific domain interprets the created transmission message based on the protocol information of the external domain detected in operation S240 (S250).

Next, the protocol interpretation unit of the specific domain supplies the interpreted transmission message to the service server of the specific domain (S260).

Next, the service server of the specific domain determines whether the interpreted transmission message received in operation S260 is to be encrypted and transmitted (S270).

If it is determined in operation S270 that the transmission message is to be transmitted without being encrypted, the method proceeds to operation S298, and the service server of the specific domain transmits the interpreted transmission message to the external domain (S298). If it is determined in operation S270 that the transmission is to be encrypted and transmitted, the method proceeds to operation S280, and the service server of the specific domain detects security information of the external domain (S280).

After operation S280, the service server of the specific domain encrypts the transmission message by using the security information detected in operation S280 (S290).

Next, the service server of the specific domain transmits the encrypted transmission message to the external domain (S295).

After operation S295 or S298 is performed, the method is terminated.

Although not described here, the method of FIG. 2 can also be applied to the system of FIG. 1.

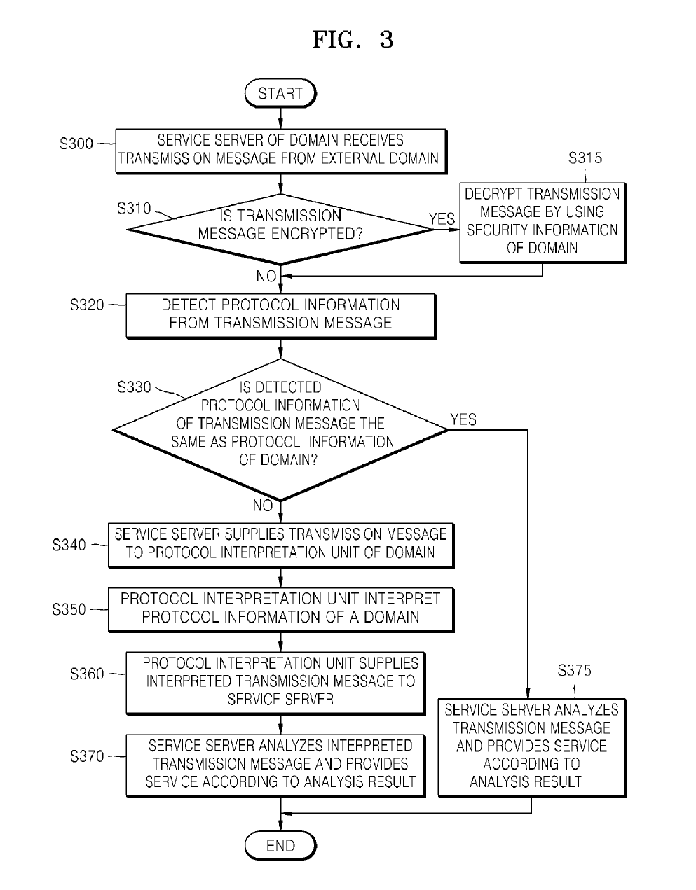

FIG. 3 is a flowchart illustrating a method of providing a service by using a message received in a heterogeneous federated environment according to an embodiment of the present invention. Referring to FIG. 3, first, a service server of a specific domain receives a transmission message from an external domain (S300).

Next, the service server of the specific domain determines whether the transmission message has been encrypted (S310).

If it is determined in operation S310 that the transmission message has been encrypted, the service server of the specific domain decrypts the transmission message by using security information of the specific domain (S315) and performs operation S320. If it is determined in operation S310 that the transmission message has not been encrypted, the service server of the specific domain performs operation S320 without decrypting the transmission message.

Next, the service server of the specific domain extracts protocol information from the transmission message (S320).

Next, the service server of the specific domain determines whether the protocol information extracted in operation S320 is the same as protocol information of the specific domain (S330).

If it is determined in operation S330 that the protocol information extracted in operation S320 is the same as protocol information of the specific domain (S330), the service server of the specific domain analyzes the transmission message and provides a service corresponding to the analysis result (S375). Otherwise, the service server of the specific domain supplies the transmission message to a protocol interpretation unit of the specific domain (S340).

Next, the protocol interpretation unit interprets the transmission message based on the protocol information of the specific domain (S350).

Next, the protocol interpretation unit of the specific domain outputs the interpreted transmission message to the service server of the specific domain (S360).

Next, the service server of the specific domain analyzes the interpreted transmission message and provides a service according to the analysis result (S370).

After operation S370 or S375 is performed, the method is terminated.

Although not described here, the method of FIG. 3 can also be applied to the system of FIG. 1.

### INDUSTRIAL APPLICABILITY

According to an aspect of the present invention, there is provided a method of transmitting a message from a domain to an external domain in a heterogeneous federated environment, the method comprising (a) a service server of the domain creating a transmission message to be transmitted to the external domain, and supplying the transmission message to a protocol interpretation unit of the domain; (b) the protocol interpretation unit of the domain detecting protocol information of the external domain; (c) the protocol interpretation unit of the domain interpreting the transmission message created in (a) based on the detected protocol information of the external domain, and supplying the interpreted transmission message to the service server; and (d) the service server of the domain transmitting the transmission message interpreted in (c) to the external domain.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

A method and apparatus for transmitting a message in a heterogeneous federated environment and a method and apparatus for providing a service by using the message, according to the present invention, has the following advantages.

First, two service servers in different domains in the heterogeneous federated environment can transform protocol information via at least a protocol interpretation unit for message compatibility.

Second, a protocol interpretation unit that interprets protocol information in the heterogeneous federated environment for message compatibility is used to exchange services between different domains. Also, since a trust relationship between domains is managed directly by a service server of each domain without external intervention, security and reliability of the heterogeneous federated environment thereby increase.

While this invention has been particularly shown and described with reference to exemplary embodiments thereof, it will be understood by those skilled in the art that various changes in form and details may be made therein without departing from the spirit and scope of the invention as defined by the appended claims

1. A method of transmitting a message from a domain to an external domain in a heterogeneous federated environment, the method comprising:
(a) a service server of the domain creating a transmission message to be transmitted to the external domain, and supplying the transmission message to a protocol interpretation unit of the domain;
(b) the protocol interpretation unit of the domain detecting protocol information of the external domain;
(c) the protocol interpretation unit of the domain interpreting the transmission message created in (a) based on the detected protocol information of the external domain, and supplying the interpreted transmission message to the service server; and
(d) the service server of the domain transmitting the transmission message interpreted in (c) to the external domain.

2. The method of claim 1, before (a), further comprising the domain and the external domain exchanging their security information and/or protocol information with each other.

3. The method of claim 1, between (c) and (d), further comprising the service server of the domain encrypting the interpreted transmission message by using the security information of the external domain,
wherein during (d), the service server of the domain transmits the encrypted transmission message to the external domain.

4. The method of claim 1, wherein (a) comprises:
(a1) the service server of the domain receiving the original message information, which is input by a user, and external domain information via a user interface;
(a2) the service server of the domain creating the transmission message from the original message information; and
(a3) the service server of the domain inserting the external domain information into the transmission message.

5. A method of providing a service, in which a domain receives a transmission message from an external domain and provides a service corresponding to the transmission message in a heterogeneous federated environment, the method comprising:
(a) a service server of the domain determining whether protocol information contained in the transmission message is the same as protocol information of the domain;
(b) when it is determined in (a) that the protocol information contained in the transmission message is not the same as protocol information of the domain , the service server of the domain supplying the transmission message to a protocol interpretation unit of the domain;
(c) the protocol interpretation unit interpreting the transmission message by using the protocol information of the domain, and supplying the interpreted result to the service server of the domain; and
(d) the service server of the domain analyzing the interpreted transmission message and providing a service according to the analysis result.

6. The method of claim 5, before (a), further comprising the domain and the external domain exchanging their security information and/or protocol information with each other.

7. The method of claim 6, between the exchange of the security information and/or the protocol information, and (a), the service server of the domain determining whether the transmission message is encrypted based on the security information of the domain; and
if it is determined that the transmission message is encrypted, the service server of the domain decrypting the transmission message by using the security information of the domain.

8. The method of claim 5, when it is determined in (a) that the protocol information contained in the transmission message and the protocol information of the domain are the same, further comprising (b′) the service server of the domain analyzing the transmission message and providing a service to the external domain according to the analysis result,
wherein (c) and (d) are not performed.

9. An apparatus for transmitting a message in a heterogeneous federated environment, the apparatus comprising:
a storage unit storing protocol information of an external domain in the heterogeneous federated environment;
a protocol interpretation unit loading the protocol information of the external domain from the storage unit, and interpreting a transmission message, which is to be transmitted to the external domain, based on the protocol information of the external domain; and
a service server creating the transmission message, supplying the transmission message to the protocol interpretation unit, receiving the interpreted transmission message from the protocol interpretation unit, and transmitting the interpreted transmission message to the external domain.

10. The apparatus of claim 9, further comprising an interface unit receiving the original message information, which is input by a user, and information regarding the external domain from the user, and transmitting the original message information and information regarding the external domain from the user to the service server.

11. The apparatus of claim 9, wherein the service server creates the transmission message based on the original message information, and inserts the information regarding the external domain to the created transmission message.

12. The apparatus of claim 9, wherein the storage unit further stores security information of the external domain in the heterogeneous federated environment.

13. The apparatus of claim 12, wherein the service server comprises a trust management unit loading the security information of the external domain from the storage unit, and encrypting the interpreted transmission message received from the protocol interpretation unit.

14. An apparatus for providing a service, in which a domain receives a transmission message from an external domain and provides a service corresponding to the transmission message in a heterogeneous federated environment, the apparatus comprising:
a storage unit storing protocol information of the domain comprising the storage unit;
a protocol interpretation unit receiving a transmission message, and interpreting the transmission message by using the protocol information loaded from the storage unit; and
a service server analyzing protocol information contained in the transmission message to determine whether the contained protocol information is the same as the protocol information of the domain, and when it is determined that the contained protocol information and the protocol information of the domain are not the same, supplying the transmission message to the protocol interpretation unit, receiving and analyzing the interpreted transmission message from the protocol interpretation unit, and providing a service according to the analysis result.

15. The apparatus of claim 14, wherein, when the service server analyzing the protocol information contained in the transmission message determines that the contained protocol information is the same as the protocol information of the domain, the service server analyses the transmission message and provides a service according to the analysis result.

16. The apparatus of claim 14, wherein the storage unit further stores security information of the domain.

17. The apparatus of claim 16, wherein the service server comprises a trust management unit determining whether the transmission message is encrypted based on the security information of the domain, and when it is determined that the transmission message is encrypted based on the security information, loading the security information and decrypting the transmission message.
